(19) United States
(12) Patent Application Publication
(10) Pub. No.: US 2004/0121093 A1
(43) Pub. Date: Jun. 24, 2004

(54) Recording paper and recording method using the same

(75) Inventors: Takashi Ogino, Ebina-shi (JP); Kiyoshi Hosoi, Ebina-shi (JP); Chizuru Koga, Ebina-shi (JP); Tsukasa Matsuda, Ebina-shi (JP)

Correspondence Address: OLIFF & BERRIDGE, PLC, P.O. BOX 19928, ALEXANDRIA, VA, 22320, US

(73) Assignee: FUJI XEROX CO., LTD, Tokyo (JP)

(21) Appl. No.: 10/653,368

(22) Filed: Sep. 3, 2003

(30) Foreign Application Priority Data
Dec. 19, 2002 (JP) 2002-368154

(51) Int. Cl. B32B 29/00

(52) U.S. Cl. 428/32.1

(57) ABSTRACT

The present invention provides a recording paper including a cellulose pulp and having an ink receiving layer with a mass per unit area being 0 g/m² or greater and less than 5 g/m² on one surface, wherein an absorption coefficient of the recording paper is in a range of 0.5 to 4, and an e/s value represented by the following equation (1) is 15.3 or less, as well as a recording method including recording on the recording paper using an inkjet ink or an electrophotographic toner.

e/s=CD shrinkage rate (%)/bending load (N) Equation (1)

### CROSS-REFERENCE TO RELATED APPLICATION

This application claims priority under 35 USC 119 from Japanese Patent Application No. 2002-368154, the disclosure of which is incorporated by reference herein.

### BACKGROUND OF THE INVENTION

1. Field of the Invention

The present invention relates to a recording paper as well as a recording method using the recording paper to perform recording with an inkjet ink or an electrophotographic toner.

2. Description of the Related Art

Inkjet recording methods have received a great deal of attention since the methods are readily applicable to a color recording system, are low in energy consumption, make little noise during recording, and reduce a fabrication cost of a printer. Recently inkjet recording methods are making advances with respect to high quality, high speed and high reliability. However, there are many machines using regular paper, and it is extremely important to increase recording suitability of these methods with respect to regular paper.

Conventional inkjet printers predominantly use a black ink containing, as the colorant, a pigment which is slow to penetrate into paper and color inks containing, as the colorant, dyes which are quick to penetrate into paper, so as to improve black letter image quality and prevent intercolor bleeding.

Since color inks have improved in penetrating ability into paper, when an image having a high recording density is printed, serious curling and warping occur immediately after printing, and there is incidence of sheet jams inside a printer and rubbing-off at an image portion. Furthermore, when two-sided printing is performed, time is required to alleviate curling which occurs immediately after printing and for the ink to dry, incurring a significant loss in printing ability. In addition, when an image having a high recording density is printed, a problem arises in that severe curling and warping occur after the ink is allowed to stand for drying, resulting in failure to achieve both a high image quality and prevention of curling and warping.

In order to solve the problems relating to image quality on regular paper, there have been proposed recording methods in which a material having an ionic character that is opposite to that of a water-soluble dye present in the ink is coated on paper, and recording is conducted using this ink containing the water-soluble dye so as to enhance ink fixation, suppression of bleeding, water resistance and color reproducibility (see, for example, Japanese Patent Application Laid-Open (JP-A) Nos. 7-257017 and 8-216498).

When employing the above-described recording methods, although image quality can be increased to some extent, sufficient improvement is not realized in suppression of intercolor bleeding. Also when printing having a high image density is performed, no improvement is achieved on suppression in curling and warping which occur immediately after printing, and in suppression of curling and warping which occur after the ink is allowed to stand for drying, which results in a document which is unsuitable for use.

Other methods have also been proposed, such as a method in which a pale colored solution containing an electrolyte is coated on a recording medium and thereafter recording is performed with a pigment-containing ink so as to increase an optical density and image fixation (see, for example, JP-A No. 11-343435), and a method in which a dissociating polyvalent metal salt is coated on a surface of paper and recording is performed with a pigment-containing ink so as to reduce darkening and bleeding, and further increase water resistance (see, for example, JP-A No. 2000-94825).

When employing the above-mentioned recording methods, image quality is improved, and furthermore, curling and warping that occur immediately after printing, as well as curling and warping that occur after the ink is allowed to stand for drying may be alleviated to some extent. However, particularly when high image density printing is performed, improvement is insufficient in suppression of curling and warping immediately after printing and in suppression of curling and warping after the ink is allowed to stand for drying, to thus produce a document unsuitable for use, since control of stretching and contracting of fibers is required.

Furthermore, there have been proposed a method in which, in order to improve suppression of curling and warping after printing, a sheet of paper is moistened once after being manufactured to alleviate stress in the sheet and thus reduce curling and warping (see, for example, JP-A No. 3-38375); a method in which an in-water elongation of paper in the CD direction is controlled so as to reduce curling and warping (see, for example, JP-A No. 3-38376); a method in which a ratio of in-water elongation of paper in the MD direction to that in the CD direction is regulated to 1.3 times or less so as to reduce curling and warping (see, for example, JP-A No. 3-199081); a method in which an in-water elongation of an ink ejected portion in a moving direction is regulated to 2.0% or less so as to reduce curling and warping (see, for example, JP-A No. 7-276786); a method in which an in-water elongation in the CD direction is regulated to below 1.8% so as to reduce curling and warping (see, for example, JP-A No. 10-46498); and a method in which a content of a pigment present in a support is set to a value in a range of 5 to 35% by weight and an internal bonding strength of a recording paper is regulated to within a range of 150 to 455 g/cm so as to decrease warping of a coat-type inkjet recording sheet (see, for example, Japanese Patent No. 3172298).

It has been reported that, when employing the methods described in the above-mentioned JP-A Nos. 3-38375, 3-38376, 3-199081 and 7-276786, reduction of curling and warping can be achieved. However, particularly when an ink that is quick to penetrate into paper is adopted and an ejected amount of the ink is large, or when a high printing speed is adopted and a larger amount of ink is ejected per unit of time, severe curling may occur, leading to suppression of ink penetration into recording paper, to thus produce a document that is unsuitable for use.

When employing the method described in the above Japanese Patent No. 3172298, while restriction of an internal bonding strength inside recording paper, which has an ink receiving layer, to a prescribed value so as to reduce warping after printing has been attempted, sufficient suppression of curling and warping cannot be obtained by merely defining an internal bonding strength. Particularly when an ink which is quick to penetrate into paper is used and an ejected amount of the ink is large, curling becomes more serious when printing speed is increased and an ejected amount of ink per unit of time is increased, and a document which is unsuitable for use is produced due to the need to reduce ink penetration into the recording paper.

Another method has been proposed in which an irreversible shrinking degree in the MD and CD directions under an altered relative humidity is adjusted to within a prescribed range so as to suppress curling and warping after the ink is allowed to stand for drying (see, for example, Japanese Patent No. 3127114).

Even if the aforementioned methods are employed, particularly when recording paper in which ink penetration is not regulated is used and when an ink which is quick to penetrate is used and an ejected amount is large, the ink is likely to penetrate into the interior of the paper, whereby an absolute amount of fibers to shrink due to drying is increased and curling after the ink is allowed to stand for drying is worsened, thus failing to suppress the curling.

### SUMMARY OF THE INVENTION

An object of the present invention is to solve the aforementioned problems. That is, the invention has as an object thereof to provide a recording paper that, when printing is performed by inkjet recording, has improved in an image quality formed on a document, is capable of suppressing curling and warping immediately after printing to thus achieve two-sided printing, is capable of suppressing curling and warping after ink is allowed to stand for drying, and that is also capable of being used in electrophotographic image forming, as well as a recording method using the recording paper.

The inventors have conducted intensive research of recording methods to improve an image quality on regular paper, to suppress curling and warping immediately after printing so as to realize the two-sided printing, and further to suppress curling and warping after ink is allowed to stand for drying.

As a result, the inventors have confirmed that curling and warping immediately after printing are caused by rapid elongation of a layer of fibers which has absorbed water present in an aqueous ink, and that warping occurs more seriously as ink is slower to penetrate within a very short time in a direction of paper thickness. The inventors have also confirmed that curling and warping after ink is allowed to stand for drying are caused by shrinkage of a layer of fibers due to dehydration of the layer of fibers having absorbed the ink and that as ink is quicker to penetrate within a very short time in the direction of paper thickness and a depth of ink penetration is larger, curling and warping after ink is allowed to stand for drying are worsened. Furthermore, the inventors have confirmed that as a bending load on paper becomes larger, a resistance force against curling is stronger, whereby curling is reduced.

Based on the aforementioned findings, the inventors have further conducted extensive research to investigate stretching and shrinking of fibers due to wetting of a layer of fibers having absorbed an ink and subsequent dehydration thereof, penetration of the ink in the direction of paper thickness, and a resistance force against curling. Consequently, the inventors have found that stretching and contracting of fibers due to wetting and dehydration has a close relation with a shrinkage rate of the paper and that by reducing the shrinkage rate, stretching and contracting of the fibers is decreased, so as to thereby make it possible to decrease curling and warping immediately after printing and curling and warping after ink is allowed to stand for drying. Moreover, as a result of investigating the resistance force against curling, the inventors have found that as a bending load on paper increases, not only curling and warping immediately after printing, but also curling and warping after ink is allowed to stand for drying can be made smaller.

Furthermore, the inventors have found that even if a CD shrinkage rate is large, reduction in curling and warping can be achieved by increasing a bending load, and hence, by decreasing a ratio of the CD shrinkage rate to the bending load.

The inventors have also conducted research of both ink and recording paper regarding ink penetration into the recording paper in the direction of paper thickness and found that if a polyvalent metal salt is present on a surface of the paper, ink penetration into the paper can be controlled, so as to thereby make it possible to decrease not only curling and warping immediately after printing, but also curling and warping after ink is allowed to stand for drying.

A first aspect of the present invention is to provide a recording paper which comprises a cellulose pulp and has an ink receiving layer with a mass per unit area being 0 g/m² or greater and less than 5 g/m² on one surface, wherein an absorption coefficient of the recording paper is in a range of 0.5 to 4, and an e/s value represented by the following equation (1) is 15.3 or less:

e/s=CD shrinkage rate (%)/bending load (N). Equation (1)

A second aspect of the invention is to provide a recording method which comprises recording using an inkjet ink on a recording paper that comprises a cellulose pulp and has an ink receiving layer with a mass per unit area being 0 g/m² or greater and less than 5 g/m² on one surface, wherein an absorption coefficient of the recording paper is in a range of 0.5 to 4, and an e/s value represented by the following equation (2) is 15.3 or less:

e/s=CD shrinkage rate (%)/bending load (N). Equation (2)

A third aspect of the invention is to provide a recording method which comprises recording using an electrophotographic toner on a recording paper that comprises a cellulose pulp and has an ink receiving layer with a mass per unit area being 0 g/m² or greater and less than 5 g/m² on one surface, wherein an absorption coefficient of the recording paper is in a range of 0.5 to 4, and an e/s value represented by the following equation (2) is 15.3 or less:

e/s=CD shrinkage rate (%)/bending load (N). Equation (2)

### BRIEF DESCRIPTION OF THE DRAWING

FIG. 1 is a graph for explaining a definition of a CD shrinkage rate.

### DETAILED DESCRIPTION OF THE INVENTION

A recording paper and a recording method according to the present invention will be described below.

<Recording Paper>

The recording paper according to the present invention comprises a cellulose pulp, and the recording paper has an ink receiving layer with a mass per unit area being 0 g/m² or greater and less than 5 g/m² on one surface, wherein an absorption coefficient of the recording paper is in a range of 0.5 to 4, and an e/s value represented by the following equation (1) is 15.3 or less:

e/s=CD shrinkage rate (%)/bending load (N). Equation (1)

The recording paper according to the invention contains a water-soluble binder and a polyvalent metal salt at one surface of the recording paper, and a content of the polyvalent metal salt is preferably in a range of from 0.1 to 2 g/m².

The e/s value is required to be 15.3 or less, is preferably 10.2 or less, and is more preferably 8.0 or less.

If the e/s value exceeds 15.3, not only curling and warping immediately after printing, but also curling and warping after ink is allowed to stand for drying becomes larger. Examples of methods of decreasing the e/s value include use of pulp having undergone suppressed beating, use of keratinized pulp, increasing a basis weight, addition of a dry paper-strengthening gent, increasing a thickness of the paper, use of a sizing agent within the paper, optimization of a filler, reducing a wet press pressure, application of restrained drying, and reducing fiber orientation.

A specific method to decrease the e/s is detailed in the sections explaining the two parameters which define the e/s value shown in equation (1), that is, “the CD shrinkage rate” and “the bending load.” Furthermore, an absorption coefficient is necessarily in the range of 0.5 to 4, preferably in the range of 1.0 to 3.5, and more preferably in the range of from 1.0 to 3.0.

If the absorption coefficient is less than 0.5, an ink penetration becomes slow and drying ability is degraded, to give rise to ink bleeding. Furthermore, not only curling to occur immediately after printing gets larger, but also the curling remains for a long time, making it hard to perform printing on a back surface in the case of two-sided printing. On the other hand, if the absorption coefficient exceeds 4.0, the ink penetrates deeper into the recording paper, making curling and warping, particularly, after the ink is allowed to stand for drying larger.

Accordingly, the recording paper according to the invention is advantageous in that in the case where printing is performed using an inkjet recording by use of a recording paper, (i) an image quality of a document can be improved, (ii) suppression of curling and warping immediately after printing can be realized to thereby enable two-sided printing, and (iii) suppression of curling and warping after the ink is allowed to stand for drying can be realized.

A conventional recording paper used in the inkjet recording system generally has the e/s value exceeding 15.3 and the absorption coefficient ranging from 3 to 4.5, and hence the features (i) to (iii) described above have not been achieved, in contrast to the recording paper of the present invention.

Next, a detailed description will be given of the parameters of “a CD shrinkage rate” and “a bending load” which define the e/s value as represented by the equation (1), and “an absorption coefficient”, specific measuring methods thereof and control methods therefor.

CD Shrinkage Rate

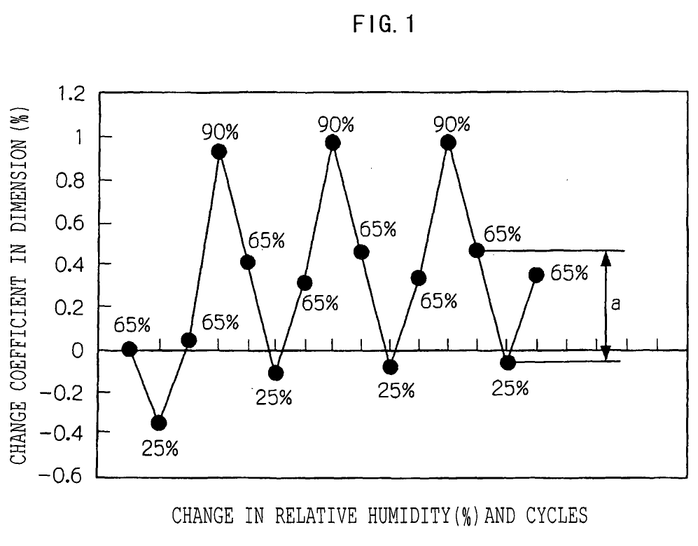

“A CD shrinkage rate” as used herein means a change coefficient in dimension of a recording paper obtained under the conditions where a recording paper is left at a constant temperature of 23° C. while a humidity is changed in 3 cycles of successively humidifying and dehumidifying to the values of 65% RH, 25% RH, 65% RH and 90% RH, followed by additional changes in humidity of from 65% RH to 25% RH (corresponding to a range defined by an arrow as shown in FIG. 1). FIG. 1 is a graph for explaining a definition of the CD shrinkage rate, wherein the ordinate is assigned to a change coefficient in dimension and the abscissa is assigned to a relative humidity (%) and the progress of humidity in the cycles and figures represented in the vicinity of symbols “⁻” show a relative humidity value. A dimension of the recording paper is measured through an H. K. type shrinkage rate tester (manufactured by Oji Engineering Co., Ltd.).

“the CD direction” means a direction to traverse a running direction of the recording paper during paper-manufacturing and when a dimension of the recording paper is measured, measurement is carried out on a dimension in the direction to traverse the running direction of the recording during paper-manufacturing.

In order to reduce the e/s value, it is preferable to decrease a CD shrinkage rate, as apparent from the equation (1). As the method for decreasing the CD shrinkage rate, there are exemplified: use of a high freeness pulp prepared by reducing a level of beating wood as the raw material, use of keratinized pulp as the raw material, optimizing a sizing agent and a filler in a paper sheet, reducing wet press pressure, reducing fiber orientation and the like.

Bending Load

“A bending load” refers to a bending load obtained by a method standardized by ISO-2493 using a bending resistance tester (manufactured by Kumagaya Riki-Kogyo K.K.) under the conditions where a measuring specimen width is 38 mm, a bending angle is 15 degrees and a weight-length is 50 mm.

In order to reduce the e/s value, it is preferable to increase the bending load, as apparent from the equation (1). As the method for increasing the bending load, there are exemplified: use of a pulp prepared by suppressing beating wood as the raw material, use of keratinized pulp as the raw material, employing a high basis weight, adding a dry paper strengthening agent, increasing a thickness of a paper sheet, reducing a wet press pressure and the like.

Absorption Coefficient

An absorption coefficient” refers to a coefficient obtained by a method standardized by JAPAN TAPPI No. 51 using a dynamic penetration tester (manufactured by Toyo Seiki Seisaku-sho, Ltd.) under the conditions where a slit width is 1 mm, a slit length is 15 mm, absorption duration comprises three steps of 40 ms, 80 ms and 200 ms, an addition amount of a liquid to a head box is 40 μl, a surface tension of the used liquid is 33 mN/m, a viscosity of an ink is 2.7 mPa.s. Incidentally, the used method standardized by JAPAN TAPPI No. 51 is called Bristow's method.

In order to control the absorption coefficient, there are exemplified: coating on or addition to paper with an ink solvent thickener, coating on or addition to paper with a surfactant, coating on paper with a surface sizing agent, use of beaten pulp, increase in density, addition of a sizing agent and a filler to paper and the like.

Specifically, there may be adopted: coating with CMC or ethylcellulose which is a solvent thickener, suppressing a penetrating effect of the sizing agent, utilizing a polymer agglomerating effect caused by the polyvalent metal salt, and the like.

The recording paper of the invention is provided on at least one surface thereof with an ink receiving layer having a mass per unit area that is 0 g/m² or greater, and less than 5 g/m², wherein the phrase “provided on at least one surface thereof with an ink receiving layer having a mass per unit area that is 0 g/m² or greater, and less than 5 g/m²,” means two cases: one case where no ink receiving layer is provided (a mass per unit area of the layer is 0 g/m²); and the other case where an ink receiving layer is provided (a mass per unit area of the layer exceeds 0 g/m² and is less than 5 g/m²).

A conventional recording paper used in the inkjet recording system is generally provided with an ink receiving layer having a mass per unit area of 8 g/m² or greater, and in the case where an image is formed on such a recording paper using an electrophotographic system, the electrophotographic system could not actually be applied since winding adhesion or other disturbances occurred in a fixing device. In order to solve such problems, it is necessary to reduce a mass per unit area of the ink receiving layer. On the other hand, since the recording paper of the invention does not comprise the ink receiving layer or the recording paper has a low mass per unit area of the ink receiving layer in the range of more than 0 g/m² and less than 5 g/m², winding adhesion and other disturbances do not occur in a fixing device even with an electrophotographic system, to thus ensure image formation.

That is, in the case where an inkjet recording system is employed, not only high quality image can be obtained, but also even when an electrophotographic system is applied thereto, an excellent document can be obtained since the recording paper of the invention achieves a high image quality and enables two-sided printing, and suppresses curling or warping.

In other words, in the case where a document is prepared using the recording paper of the invention, any of an electrophotographic system and an inkjet recording system can be adopted if only a basic function as a document is required in such a level that not too high image quality is required, and letters and images have only to be sufficiently readable, while in the case where a high quality document such as to be applicable to a catalogue or the like is required, an inkjet recording system can be adopted. In such a manner, a recording system may be selected depending on the purposes of documents.

The recording paper of the invention contains well known cellulose pulp. Specifically, there may be used a chemical pulp. And more specifically, usable are hardwood bleached kraft pulp, hardwood unbleached kraft pulp, softwood bleached kraft pulp, softwood unbleached kraft pulp, hardwood bleached sulfite pulp, hardwood unbleached sulfite pulp, softwood bleached sulfite pulp, softwood unbleached sulfite pulp and the like, as well as the pulp produced by chemically treated raw fibers from wood, cotton, hemp, bast and the like.

As pulps, there may also be used ground wood pulp produced as pulp through a mechanical treatment from logs or chips of wood, chemical and mechanical pulp produced as pulp through a mechanical treatment of logs and chips of wood that were preliminarily impregnated with a chemical agent, and thermo-mechanical pulp produced as pulp by digesting logs and chips of wood, followed by application of a refiner into a pulp state. These virgin pulps may be singly used or, if necessary, mixed with recycled pulp.

The pulp is preferably subjected to a bleaching treatment using chlorine dioxide without using chlorine gas (Elementally Chlorine Free; ECF bleaching method) or a bleaching treatment mainly using ozone/hydrogen peroxide without using any chlorine containing compound (Totally Chlorine Free; TCF bleaching method).

Furthermore, as the raw material of recycle pulp, there may be used: non-printed waste paper having grades of best white, special white, medium white and discolored white and the like obtained as cutting-off, damaged papers, trimming-off generated in a bookbinding factory, a printing factory, a cutting factory and the like; wood-free paper on which printing or copying is performed; recycled wood-free paper such as wood-free coat paper; recycle paper printed with an aqueous ink, an oily ink or a pencil thereon; printed wood-free paper; wood-free coat paper; recycled news papers including leaflets such as those of a medium quality paper, a medium quality coat paper and the like; and waste papers including a medium quality paper, a medium quality coat paper, ground wood papers and the like.

In the case where recycle pulp is used for the recording paper of the invention, raw material for waste paper described above is preferably subjected to at least one of an ozone bleaching treatment and a hydrogen peroxide bleaching treatment. In order to obtain paper exhibiting high brightness, it is preferable that a mixing proportion of recycled pulp obtained by the above bleaching treatment ranges from 50% to 100%. In addition, from the viewpoint of recycling natural resources, it is more preferable that a mixing proportion of waste paper ranges from 70% to 100%. An ozone treatment has an action to decompose a fluorescent dye generally contained in wood-free paper, and a hydrogen peroxide treatment has a function to prevent yellowing caused by alkali used for removing ink. Particularly, it has been known that through a treatment of the both bleaching systems combined, not only removing ink from waste paper is facilitated, but also a brightness of treated pulp is further enhanced. Moreover, through another function of decomposing and removing chlorine-containing compounds remained in pulp, the bleaching treatment have a considerable effect of reducing an organic halide content in waste paper which is produced from pulp chlorine-bleached pulp.

Further, to the recording paper of the invention is preferably added the filler in order to adjust an opacity, a brightness and a surface quality. Particularly in the case where a decrease in halogen content in paper is desired, it is preferable to use a chlorine-free filler. As such fillers used for this purpose, there are exemplified: white inorganic pigments such as calcium carbonate heavy, precipitated calcium carbonate, chalk, kaolin, calcined clay, talc, calcium sulfate, barium sulfate, titanium dioxide, zinc oxide, zinc sulfide, zinc carbonate, aluminum silicate, calcium silicate, magnesium silicate, synthetic silica, aluminum hydroxide, alumina, sericite, white carbon, saponite, calcium montmorillonite, sodium montmorillonite, bentonite and the like; and organic pigments such as acrylic type plastic pigment, polyethylene, urea resin and the like. Besides, in the case where waste paper is incorporated, an ash content in raw waste paper must preliminarily be adjusted with respect to the addition amount of the waste paper.

Furthermore, to the recording paper of the invention is preferably added an internal sizing agent. As the internal sizing agent, there can be used: a neutral rosin sizing agent, an alkenyl succinic anhydride (ASA), alkylketene dimer (AKD) and a petroleum resin sizing agent, which are conventionally used for manufacturing paper.

Moreover, the recording paper of the invention may be provided with an ink receiving layer on at least one surface thereof.

As the materials to form the ink receiving layer, there may be used: oxidized starch, cationized starch, polyvinyl alcohol, a polymeric water absorbent and the like, to which silica, alumina, calcium carbonate or the like may be added. In addition, there may also be added a material capable of suppressing penetration of the ink, such as the polyvalent metal salt and a thickener. The ink receiving layer may be formed by coating a solution containing the above-described materials for forming the ink receiving layer, to provide a mass per unit area in the range of more than 0 g/m² and less than 5 g/m² using a coating blade, a coating bar or the like. In the case where an ink receiving layer having a mass per unit area greater than 5 g/m² is formed by coating, a problem arises in that winding adhesion occurs in a fixing device of an electrophotographic printer, resulting in paper sheet jam.

Although there is not specific limitation on a basis weight of the recording paper of the invention, it is preferably in the range of from 60 to 128 g/m², more preferably in the range of from 60 to 100 g/m², and still more preferably in the range of from 60 to 90 g/m². While with increasing basis weight, suppression of curling and warping is advantageously realized. If the basis weight exceeds 128 g/m², a bending resistance of paper becomes excessively large, resulting in lowered traveling ability of a recording paper inside a printer. On the other hand, if the basis weight is lower than 60 g/m², curling and warping may not sometimes be inhibited, to cause an undesirable incidence of offset.

The recording paper of the invention preferably contains the polyvalent metal salt at a surface thereof. If the surface of the recording paper contains the polyvalent metal salt, an anionic polymer present in the inkjet ink may effect cross-linking to thereby render colorants to agglomerate very fast, achieve an excellent print image quality and also suppress penetration of an ink solvent into the paper sheet, whereby there may be realized further suppression of curling and warping immediately after printing, and curling and warping after the ink is allowed to stand for drying.

As the polyvalent metal salt, there can be used: chlorides, sulfates, nitrates, formates, acetates and the like of polyvalent metals such as potassium, barium, calcium, magnesium, zinc, tin, manganese, aluminum. In more detail, there are exemplified: barium chloride, calcium chloride, calcium acetate, calcium nitrate, calcium formate, magnesium chloride, magnesium sulfate, magnesium nitrate, magnesium acetate, magnesium formate, zinc chloride, zinc sulfate, zinc nitrate, zinc formate, stannic chloride, stannic nitrate, manganese chloride, manganese sulfate, manganese nitrate, manganese formate, aluminum sulfate, aluminum nitrate, aluminum chloride, aluminum acetate and the like, which may be used either alone or in combination of two or more kinds thereof. Among the polyvalent metal salts described above, preferably used is the polyvalent metal salt having a high solubility in water. Furthermore, if a counter ion of the polyvalent metal salt is of a strong acid, yellowing of a paper sheet may take place after coating. Therefore, preferably used are calcium chloride, calcium formate, magnesium chloride, magnesium formate and the like.

The polyvalent metal salt listed above is coated on a surface of the recording paper in a preparation process, to thereby allow the metal salt present on the surface of the recording paper. Upon coating, a coating solution obtained by dissolving the polyvalent metal salt in water may be applied directly on the surface of the recording paper, however, the coating solution is generally applied as a mixture with a binder.

As the binder, oxidized starch, phosphoric esterified starch, captively modified starch, cationized starch, various kinds of modified starch, polyethylene oxide, polyacrylamide, sodium polyacrylate, sodium alginate, hydroxymethylcellulose, calboxymethylcellulose, methylcellulose, polyvinyl alcohol, and the derivatives thereof may be used alone or in admixture thereof without any specific limitation.

A sizing degree of the recording paper may be adjusted by properly selecting the kinds of the binder and a mixing proportion thereof. In the case where the sizing degree cannot be sufficiently adjusted using the binder described above, a surface sizing agent may be added.

As the surface sizing agent, there may be used: a rosin sizing agent, a synthetic sizing agent, a petroleum resin sizing agent, a neutral sizing agent, starch, polyvinyl alcohol and the like. In the case where a decrease in a halogen content is desired in the recording paper, it is preferable to use the internal sizing agent or the surface sizing agent which is free of chlorine. Specifically, there may be used: a rosin sizing agent, a synthetic sizing agent, a petroleum resin sizing agent, a neutral sizing agent and the like. It is preferable to use the neutral sizing agent from the viewpoint of improving preservability of the recording paper. The sizing degree is controlled by an addition amount of the sizing agent used. A Stoekigt sizing degree is preferably in the range of 10 sec to 60 sec.

Then, the obtained solution may be coated on body paper through conventional coating means such as a size press, a shim size, a gate roll, a roll coater, a bar coater, an air knife coater, a rod blade coater, a blade coater or the like. Thereafter, a drying step is carried out, to thereby obtain the recording paper of the invention.

A content of the polyvalent metal salt at a surface of the recording paper is preferably in the range of 0.1 to 2 g/m², and more preferably in the range of 0.5 to 1.5 g/m².

If the content is less than 0.1 g/m², a reactivity with a pigment or an anionic polymer in an ink is lowered and, as a result, image quality is impaired to thereby increase curling and warping immediately after printing, and curling and warping after the ink is allowed to stand for drying. On the other hand, if the content exceeds 2 g/m², penetration of the ink is lowered to thereby worsen ink drying when conducting high speed printing.

In order to control penetration of the coating solution into body paper in the coating process, it is preferable that body paper, prior to coating, is subjected to calendering or the like to adjust gas permeability of a body paper within a range of from 10 sec to 30 sec. This is due to the facts that if gas permeability of body paper is large, it is possible to suppress penetration of the coating solution into paper. If gas permeability of body paper is excessively high, ink penetration is inhibited when printing is performed using the inkjet recording system, leading to intercolor bleeding and poorer dryness.

It is an effective method for decreasing penetration of the coating solution into body paper to increase a viscosity of the coating solution using starch, polyvinyl alcohol or the derivative thereof as the binder.

It is another effective method for decreasing penetration of the coating solution into body paper to separately apply a size press process onto paper obtained by drying without applying a size press after a process of manufacturing paper.

It is also preferable to reduce fiber orientation in the recording paper of the invention. As methods to reduce fiber orientation, there are exemplified: adjustment of a JET/WIRE (a raw material jet speed/a paper machine wire speed), control of a paper tension in the machine direction during press and a paper tension in the machine direction during drying inside a dryer and other means.

<Recording Method>

Hereinafter, description will be given of the recording method of the invention.

The present invention is directed to a recording method comprising recording using an inkjet ink or an electrophotographic toner on a recording paper which comprises a cellulose pulp, and the recording paper has an ink receiving layer with a mass per unit area being 0 g/m² or greater and less than 5 g/m² on one surface, wherein an absorption coefficient of the recording paper is in a range of 0.5 to 4, and an e/s value represented by the following equation (2) is 15.3 or less:

e/s=CD shrinkage rate (%)/bending load (N). Equation (2)

In the recording method of the invention, no specific limitation is imposed on the recording method insofar as the recording paper of the invention is used when recording is carried out using an inkjet ink (hereinafter sometimes simply referred to as “an ink”) or an electrophotographic toner (hereinafter sometimes simply referred to as “a toner”). The recording method of the invention is, however, preferably conducted using the inkjet recording system in order to create high quality printed image.

In the recording method of the invention, it is preferable that the inkjet ink preferably contains a water-soluble colorant and has a surface tension in the range of 25 to 37 mN/m.

In the recording method of the invention, the inkjet ink contains a water-soluble polymer having at least a hydrophobic moiety and a hydrophilic moiety in a molecule thereof and has a surface tension in the range of 25 to 37 mN/n.

Detailed description will now be given of a case where the recording method of the invention is carried out through an inkjet recording system using the ink of the invention. Application of the recording method of the invention is not limited to the system, but the recording method may be conducted through the electrophotographic system using the toner. In the case where the electrophotographic system is adopted, any kind of conventional toner may be used.

The ink used in the recording method (the inkjet recording system) of the invention is detailed below.

For use as the ink in the recording method of the invention, there is not any specific limitation, insofar as it is a well known ink containing at least the colorant. It is preferable that the ink essentially contains the colorant, an anionic compound, a water-soluble organic solvent and water, and further contains a pigment dispersant, a surfactant, various kinds of additives and the like. Individual components are explained below.

1) Colorant

The colorant used in the ink may be any of a water-soluble dye, an organic pigment and an inorganic pigment.

In case of a black ink, it is general to mainly contain a pigment. As the black pigment, there are exemplified: carbon black pigments such as furnace black, lamp black, acetylene black, channel black and the like. In more detail, Raven 7000, Raven 5750, Raven 5250, Raven 5000 ULTRA II, Raven 3500, Raven 2000, Raven 1500, Raven 1250, Raven 1200, Raven 1190 ULTRA II, Raven 1170, Raven 1255, Raven 1080 and Raven 1060 (all of the black pigments described above are manufactured by Columbian Chemicals Company); Regal 1400R, Regal 1330R, Regal 1660R, Mogul L, Black Pearls L, Monarch 700, Monarch 800, Monarch 880, Monarch 900, Monarch 1000, Monarch 1100, Monarch 1300 and Monarch 1400 (all of the black pigments described above are manufactured by Cabot Corporation); Color Black FW1, Color Black FW2, Color Black FW2V, Color Black 18, Color Black FW 200, Color Black S150, Color Black S160, Color Black S170, Pritex 35, Pritex U, Pritex V, Printex 140U, Printex 140V, Special Black 6, Special Black 5, Special Black 4A and Special Black 4 (all of the black pigments described above are manufactured by Deggusa Co.); No. 25, No. 33, No. 40, No. 47, No. 52, No. 900, No. 2300, MCF-88, MA 600, MA7, MA8 and MA100 (all of the black pigments described above are manufactured by Mitsubishi Chemical Co., Ltd.).

Although suitable type of carbon black cannot be simply discussed, preferable characteristics thereof are a particle diameter ranging from 15 to 30 nm, a BET specific surface area ranging from 70 to 300 m²/g, a DBP oil absorption value ranging from 0.5 to 1.0×10⁻³ L/g, a volatile content ranging from 0.5 to 10% by weight, and an ash content ranging from 0.01 to 1.00% by weight. If carbon black having characteristics outside the above range is used, a diameter of dispersed particles in the ink may sometimes become large.

As the colorant used in cyan, magenta and yellow inks, there may be used dyes, any kind of pigments having a hydrophilicity that are obtained by adding a dispersant carrying a hydrophilic group to a hydrophobic pigment, and self-dispersible pigments.

As the water-soluble dye, a well known dye and a newly synthesized dye may be used. Among them, preferable are a direct dye and an acidic dye since a vivid color hue can be achieved. Specifically, there are exemplified: C. I. Direct Blue-1, -2, -6, -8, -22, -34, -70, -71, -76, -78, -86, -142, -199, -200, -201, -202, -203, -207, -218, -236 and -287; C. I. Direct Red-1, -2, -4, -8, -9, -11, -13, -20, -28, -31, -33, -37, -39, -51, -59, -62, -63, -73, -75, -80, -81, -83, -87, -90, -94, -95, -99, -101, -110 and -189; C. I. Direct Yellow-1, -2, -4, -8, -11, -12, -26, -27, -28, -33, -34, -41, -44, -48, -86, -87, -88, -135, -142 and -144; C. I. Acid Blue-1, -7, -9, -15, -22, -23, -27, -29, -40, -43, -55, -59, -62, -78, -80, -81, -90, -102, -104, -111, -185, and -254; C. I. Acid Red-1, -4, -8, -13, -14, -15, -18, -21, -26, -35, -37, -249 and -257; C. I. Acid Yellow-1, -3, -4, -7, -11, -12, -13, -14, -19, -23, -25, -34, -38, -41, -42, -44, -53, -55, -61, -71, -76, -79; and the like, which may be used either alone or in combination of two or more kinds thereof.

As the cationic dye, there are exemplified: C. I. basic yellow -1, -11, -13, -19, -25, -33 and -36; C. I. basic red -1, -2, -9, -12, -13, -38, -39 and -92; and C. I. basic blue -1, -3, -5, -9, -19, -24, -25, -26 and -28 and the like.

Specific examples of the cyan pigment include C. I. Pigment Blue-1, C. I. Pigment Blue-2, C. I. Pigment Blue-3, C. I. Pigment Blue-15, C. I. Pigment Blue-15:1, C. I. Pigment Blue-15:3, C. I. Pigment Blue-15:4, C. I. Pigment Blue-16, C. I. Pigment Blue-22, C. I. Pigment Blue-60 and the like.

Specific examples of the magenta pigment include C. I. Pigment Red-5, C. I. Pigment Red-7, C. I. Pigment Red-12, C. I. Pigment Red-48, C. I. Pigment Red-48: 1, C. I. Pigment Red-57, C. I. Pigment Red-112, C. I. Pigment Red-122, C. I. Pigment Red-123, C. I. Pigment Red-146, C. I. Pigment Red-168, C. I. Pigment Red-184, C. I. Pigment Red-202 and the like.

Specific examples of the yellow pigment include C. I. Pigment Yellow-1, C. I. Pigment Yellow-2, C. I. Pigment Yellow-3, C. I. Pigment Yellow-12, C. I. Pigment Yellow-13, C. I. Pigment Yellow-14, C. I. Pigment Yellow-16, C. I. Pigment Yellow-17, C. I. Pigment Yellow-73, C. I. Pigment Yellow-74, C. I. Pigment Yellow-75, C. I. Pigment Yellow-83, C. I. Pigment Yellow-93, C. I. Pigment Yellow-95, C. I. Pigment Yellow-97, C. I. Pigment Yellow-98, C. I. Pigment yellow-114, C. I. Pigment yellow-128, C. I. Pigment Yellow-129, C. I. Pigment Yellow-151, C. I. Pigment Yellow-154 and the like.

The pigment for use in the invention may be a pigment that is self-dispersible into water (a self-dispersible pigment). The self-dispersible pigment is a pigment having a large number of water-soluble groups on the surface thereof and is stably dispersed even in the absence of a pigment dispersant. Specifically, the self-dispersible pigment may be obtained by subjecting a so-called ordinary pigment to a surface modifying treatment such as an acid base treatment, a coupling agent treatment, a polymer graft treatment, a plasma treatment, an oxidation/reduction treatment. Beside, the pigments to have experienced such a surface modifying treatment, additional pigments such as cab-o-jet 200, cab-o-jet-300, IJX-55, IJX-253, IJX-266 and IJX-273 (manufactured by Cabot Corporation); Nicrojet Black CW-1 (manufactured by Orient Chemical Industries, Ltd.); pigments distributed Nippon Shokubai Co., Ltd. and the like may be used.

Although water-soluble groups present on the surface of the self-dispersible pigment may be any of groups having nonionic properties, cationic properties and anionic properties, particularly desirable are those of sulfonic acid, carboxylic acid, a hydroxyl group and phophoric acid. In the case of sulfonic acid, carboxylic acid and phosphoric acid, the acids may be used in a state of a free acid, however, these acids are preferably used in the form of a salt with a basic compound.

As the basic compound, there may be used: alkali metals such as sodium, potassium, lithium and the like; aliphatic amines such as monomethylamine, dimethylamine, trimethylamine and the like; alcohol amines such as monoethanol amine, monoethanol amine, diethanol amine, triethanol amine, diisopropanol amine and the like; and basic compounds such as ammonia. Among them, particularly preferable are basic compounds of alkali metals such as sodium, potassium, lithium and the like. This is presumably due to the fact that because basic compounds of alkali metals are strong electrolytes, the compounds have an effect of accelerating dissociation of an acidic group.

In the case where the pigment is contained in the ink as the colorant, the content of the pigment preferably ranges from 0.5 to 20% by weight, and particularly preferably in the range from 2 to 10% by weight. If the content of the pigment is less than 0.5%, a sufficient optical density may not occasionally be obtained. On the other hand, if the content is more than 20% by weight, image fixation may be deteriorated.

In the case where the dye is contained in the ink as the colorant, the content of the dye is in the range of 0.1 to 10% by weight, preferably in the range of 0.5 to 8% by weight, and more preferably in the range of 0.8 to 6% by weight. If the content of the dye is more than 10% by weight, clogging at a printing head tip is likely to occur. On the other hand, if less than 0.1% by weight, a sufficient image density cannot sometimes be obtained.

2) Anionic Water-Soluble Polymer

As the anionic water-soluble polymer used in inks, there are exemplified: acids such as carboxylic acid, sulfonic acid and the like; derivatives thereof; and an anionic polymer emulsion and the like. Further, an anionic pigment dispersant to be described later may also be used as the anionic water-soluble polymer.

Specific examples of the carboxylic acid include formic acid, acetic acid, propionic acid, butyric acid, valeric acid, lactic acid, tartaric acid, benzoic acid, acrylic acid, crotonic acid, butenic acid, methacrylic acid, tiglic acid, allylic acid, 2-ethyl-2-butenic acid, oxalic acid, malonic acid, succinic acid, glutaric acid, maleic acid, fumaric acid, methylmaleic acid, glyceric acid and the like; the polymers and derivatives thereof; and the like. Furthermore, there may also be used alkali metal salts, alkali earth metal salts and ammonium salts of the compounds described above.

Specific examples of the sulfonic acid include benzenesulfonic acid, toluenesulfonic acid, xylenesulfonic acid, benzenedisulfonic acid, benzenetrisulfonic acid, hydroxybenzenesulfonic acid, chlorobenzenesulfonic acid, bromobenzenesulfonic acid, 4-hydroxy-1,3-benzenesulfonic acid, sodium 4,5-dihydroxybenzene-1,3-disulfonate, o-aminobenzenesulfonic acid; and further the derivatives thereof; and alkali metal salts, alkali earth metal salts and ammonium salts of the sulfonic acids described above.

These compounds are preferably used in the form of a salt with a basic compound in order to increase water-solubility. As the compound for forming salts with the compound described above, there may be used: alkali metals such as sodium, potassium, lithium and the like; aliphatic amines such as monomethyl amine, dimethyl amine, trimethyl amine and the like; alcohol amines such as monomethanol amine, monoethanol amine, diethanol amine, triethanol amine, diisopropanol amine and the like; ammonia; and the like.

Representative examples of the anionic water-soluble polymer include acrylic acid alkyl ester-acrylic acid copolymer, styrene/methacrylic acid alkyl ester/methacrylic acid copolymer, styrene/maleic acid copolymer, styrene/methacrylic acid copolymer, styrene/acrylic acid copolmyer, methacrylic acid alkyl ester/methacrylic acid copolymer, styrene/acrylic acid alkyl ester/acrylic acid copolymer, styrene/methacrylic acid phenyl ester/methacrylic acid copolymer, styrene/methacrylic acid cyclohexyl ester/methacrylic acid copolymer and the like; and the salts and derivatives of the copolymer described above.

It is preferable that the anionic water-soluble polymer contained in the ink has the hydrophilic moiety and the hydrophobic moiety, and furthermore, contains a carboxylic acid or a salt of a carboxylic acid as a functional group constituting the hydrophilic moiety.

Specifically, a monomer to constitute the hydrophilic moiety of the anionic water-soluble polymer is one or more kinds of the monomer selected from the group consisting of acrylic acid, methacrylic acid and maleic anhydride.

The monomer to constitute the hydrophobic moiety of the anionic compound is styrene, styrene derivatives such as α-methylstyrene, vinyltoluene and the like; vinylcyclohexane, vinylnaphthalene, vinylnaphthalene devrivative, acrylic acid alkyl ester, methacrylic acid alkyl ester, methacrylic acid phenyl ester, methacrylic acid cycloalkyl ester, crotonic acid alkyl ester, itaconic acid dialkyl ester, maleic accid dialkyl ester and the like. Among them, preferable is one or more kinds the monomer selected from the group consisting of styrene and alkyl, aryl, and alkylaryl esters of (meth)acrylic acid.

The anionic water-soluble polymers described above may be used singly or in combination of two or more kinds thereof. It is preferable that the content of the anionic water-soluble polymer in the ink ranges from 0.1 to 10% by weight, and particularly preferably in the range from 0.3 to 5% by weight. If the content is less than 0.1% by weight, a long term storability is poor and the optical density is reduced. If the content exceeds 10% by weight, ink ejection is not properly exerted and the optical density may be reduced.

3) Water-Soluble Organic Solvent

As the water-soluble organic solvent used in the ink, there are exemplified: polyhydric alcohols such as ethylene glycol, diethylene glycol, propylene glycol, butylene glycol, triethylene glycol, 1,5-pentanediol, 1,2,6-hexanetriol, glycerin and the like; derivatives of polyhydroxy alcohols such as ethylene glycol monomethyl ether, ethylene glycol monoethyl ether, ethylene glycol monobutyl ether, diethylene glycol monomethyl ether, dieethylene glycol monoethyl ether, diethylene glycol monobutyl ether, propylene glycol monobutyl ether, dipropylene glycol monobuyl ether and the like; nitrogen containing solvents such as pyrrolidone, N-methyl-2-pyrrolidone, cyclohexylpyrrolidone, triethanol amine and the like; alcohols such as ethanol, isopropyl alcohol, butyl alcohol, benzyl alcohol and the like; sulfur containing solvents such as thiodiethanol, thidiglycerol, sulfolan, dimethylsulfoxide and the like; and propylene carbonate, ethylene carbonate and the like. The water-soluble organic solvents may be used singly or in combination of two or more kinds thereof.

It is preferable that the content of the water-soluble organic solvent in the ink ranges from 1 to 60% by weight, and particularly preferably in the range of 5 to 40% by weight. If the content of the water-soluble organic solvent is less than 1% by weight, a long term storability may become poor. On the other hand, if the content exceeds 60% by weight, ejecting stability may sometimes be reduced, occasionally leading to ejecting disturbance.

4) Water

Water used in the ink may be any of ion-exchanged water, distilled water, pure water, ultrapure water and the like.

It is preferable that water content in the ink ranges from 15 to 98% by weight, and particularly preferably in the range from 45 to 90% by weight. If the content is less than 15% by weight, ejecting stability may be reduced, sometimes leading to ejecting disturbance. On the other hand, if the content is in excess of 98% by weight, a long term storability may become poor.

5) Other Components

Pigment Ink and Pigment Dispersant

The pigment dispersant may be incorporated in order to disperse pigments that are contained in the ink. As specific examples of the pigment dispersant, there are exemplified: a polymer dispersant, an anionic surfactant, a cationic surfactant, an ampholytic surfactant, a nonionic surfactant and the like.

As used herein, the pigment dispersant which is transformed into an organic anion in an ionized state in water is referred to as an anionic pigment dispersant. An anionic water-soluble polymer described above may be used as the anionic pigment dispersant.

As the polymer dispersant, there may be effectively used any polymer having the hydrophilic moiety and the hydrophobic moiety. A condensation polymer and an addition polymer are used as the polymer having the hydrophilic moiety and the hydrophobic moiety.

As examples of the condensation polymer, there is exemplified a well known polyester-based dispersant. As examples of the addition polymer, there is exemplified the addition polymer of a monomer having an α,β-ethylenically unsaturated group. A desired polymer dispersant can be obtained by suitably copolymerizing a monomer having an α,β-ethylenically unsaturated group and a hydrophilic group, with a monomer having an α,β-ethylenically unsaturated group and a hydrophobic group. Furthermore, as the polymer dispersant, there may also be used a homopolymer of a monomer having an α,β-ethylenically unsaturated group and a hydrophilic group.

As examples of the monomer having an α,β-ethylenically unsaturated group and a hydrophilic group, there are exemplified: monomers having a carboxyl group, a sulphonic group, a hydroxyl group and a phosphoric group. Specific examples thereof include acrylic acid, methacrylic acid, crotonic acid, itaconic acid, itaconic acid monoester, maleic acid, maleic acid monoester, fumaric acid, fumaric acid monoester, vinyl sulfonic acid, styrene sulphonic acid, sulfonated vinylnaphthalene, vinyl alcohol, acrylamide, methacryloxyethyl phosphate, bismethacryloxyethyl phosphate, methacryloxyethyl phenyl acid phosphate, ethylene glycol dimethacrylate, diethylene glycol dimethacrylate and the like.

As examples of the monomer having an α,β-ethylenically unsaturated group and a hydrophobic group, there are exemplified: styrene, styrene derivatives such as a-methylstyrene, vinyltoluene and the like; vinylcyclohexane, vinylnaphthalene, vinylnaphthalene devrivative, acrylic acid alkyl ester, acrylic acid phenyl ester, methacrylic acid alkyl ester, methacrylic acid phenyl ester, methacrylic acid cycloalkyl ester, crotonic acid alkyl ester, itaconic acid dialkyl ester, maleic accid dialkyl ester and the like.

As examples of the preferable copolymers of the monomer, there are exemplified: styrene/styrene sulfonic acid copolymer, styrene/maleic acid copolymer, styrene/methacrylic acid copolymer, styrene/acrylic acid copolmyer, vinylnaphthalene/maleic acid copolymer, vinylnaphthalene/methacrylic acid copolymer, vinylnaphthalene/acrylic acid copolymer, acrylic acid alkyl ester/acrylic acid copolymer, methacrylic acid alkyl ester/methacrylic acid copolymer, styrene/methacrylic acid alkyl ester/methacrylic acid copolymer, styrene-acrylic acid alkyl ester/acrylic acid copolymer, styrene/methacrylic acid phenyl ester/methacrylic acid copolymer, styrene/methacrylic acid cyclohexyl ester/methacrylic acid copolymer and the like.

Furthermore, there may be used copolymers obtained by suitably copolymerizing a monomer having a polyoxyethylene group and a hydroxyl group with the above listed copolymer. Moreover, in order to enhance affinity with the pigment having an acidic functional group on the surface of particles and to improve dispersion stability, there may be used copolymers obtained by properly copolymerizing any of monomers having a cationic functional group, such as N,N-dimethylaminoethyl methacrylate, N,N-dimethylaminoethyl acrylate, N,N-dimethylaminomethacrylamide, N,N-dimethylaminoacrylamide, N-vinylpyrrole, N-vinylpyridine, N-vinylpyrrolidone, N-vinylimidazole and the like.

The copolymers described above may be any of a random copolymer, a block copolymer, a graft copolymer and the like. Besides, there may be used: polystyrene sulfonic acid, polyacrylic acid, polymethacrylic acid, polyvinyl sulfonic acid, polyalginic acid, polyoxyethylene/polyoxypropylene/polyoxyethylene block copolymer, a formalin condensate of naphthalene sulfonic acid, polyvinylpyrrolidone, polyethyleneimine, polyamines, polyamides, polyvinylimidazoline, aminoalkyl acrylate/acrylamide copolymer, chitosan, polyoxyethylene fatty amide, polyvinyl alcohol, polyacrylamide, cellulose derivatives such as carboxymethylcellulose, carboxyethylcellulose and the like, and polysaccharides and the derivatives thereof.

It is preferable, without any limitation, that a hydrophilic group of the pigment dispersant is carboxylic acid or the salt thereof.

A neutralization amount of the pigment dispersant is preferably 50% or more, and particularly preferably 80% or more relative to an acid value of a copolymer. It is preferable that a molecular weight of the pigment dispersant ranges from 2,000 to 15,000, and particularly preferably in the range of from 3,500 to 10,000 in terms of weight average molecular weight (Mw). Furthermore, structures of and compositional ratios between the hydrophobic moiety and the hydrophobic moiety may be preferably selected from combinations of pigments and solvents used.

The pigment dispersants may be used singly or in combination of two or more kinds thereof. Although the addition amount of the pigment dispersant cannot simply be specified since the amount differs greatly depending on the pigment used, the amount is generally in the range of 0.1 to 100% by weight, preferably in the range of 1 to 70% by weight, and more preferably in the range of 3 to 50% by weight relative to the weight of the pigment.

Surfactant

The ink may also contain a surfactant. The surfactant is added in order to control the pigment dispersant in the pigment ink and adjust a surface tension and wettability of the ink, or in order to dissolve organic impurities and improve reliability of ejecting ink from a nozzle.

As the surfactant, preferable are nonionic and anionic surfactants that do not adversely affect a dispersed state of the water-insoluble colorant or a dissolved state of the water-soluble dye. As the nonionic surfactant, there may be used: polyoxyethylenenonyl phenyl ether, polyoxyethyleneoctyl phenyl ether, polyoxyethylenedodecyl phenyl ether, polyoxyethylenealkyl ether, polyoxyethylene fatty ester, sorbitan fatty ester, polyoxyethylenesorbitan fatty ester, fatty alkylolamide, acetylene alcohol ethyleneoxide adduct, polyethylene glycol polypropylene glycol block polymer, polyoxyethylene ether of glycerin ester, polyoxyethylene ether of sorbitol ester and the like. As the anionic surfactant, there may be used: an alkylbenzene sulfonate, an alkylphenyl sulfonate, an alkylnaphthalene sulfonate, a higher fatty acid salt, a sulfate ester and a sulfonate of a higher fatty acid ester, a higher alkylsulfosuccinate and the like. As the ampholytic surfactant, there may be used: betain, sulfobetain, sulfate betain, imidazoline and the like. In addition to the above, there are exemplified: silicone type surfactants such as a polyoxyethylene adduct of polysiloxane; fluorine containing surfactants such as an oxyethyleneperfluoroalkyl ether and the like; biosurfactants such as Spiculispor acid, rhamnolipid, lysolecithin and the like. The suitable surfactants may be used alone or in combination of two or more kinds thereof. The addition amount may be adjusted depending on desired characteristics such as the surface tension or the like.

Other Additives

Further, there may be added to the ink, as necessary, a pH buffering agent, an antioxidant, a fungicide, a viscosity adjusting agent, an electronically conductive agent, a UV absorbent, a chelating agent, a water-soluble dye, a disperse dye, an oil-soluble dye and the like. The addition amount of the additive is preferably 20% by weight.

Method of Preparing Ink

The above described ink may be prepared by a process comprising admixing a prescribed amount of the colorant to an aqueous solution while sufficiently stirring, dispersing the colorant using a dispersing machine, removing coarse particles via centrifugation or the like, thereafter adding a prescribed solvent, additive or the like to the dispersion, stirring and mixing the resultant dispersion, followed by filtration.

Commercially available dispersing machines may be used. There are exemplified: a colloid mill, a flow jet mill, a slasher mill, a high speed disperser, a ball mill, an attriter, a sand mill, a sand grinder, an ultrafine mill, an eiger motor mill, a dyno mill, a pearl mill, an agitator mill, a cobol mill, a three-roll mill, a two-roll mill, an extruder, a kneader, a micro-fluidizer, a laboratory homgenizer, an ultrasonic homogenizer and the like, which may be used singly or in combination thereof. It is preferable to employ a dispersing method without using a dispersing vehicle in order to prevent contamination of inorganic impurities, preferably employing a micro-fluidizer, an ultrasonic homogenizer and the like. In the Examples of the invention to be described later, dispersing operation is performed using an ultrasonic homogenizer.

The ink that contains the self-dispersible pigment may be prepared by a process comprising subjecting the pigment to a surface modifying treatment, adding the resultant pigment to water followed by sufficiently stirring, optionally dispersing the pigment using the dispersing machine in a similar manner to the above, removing coarse particles via centrifugation or the like, adding a prescribed solvent, additive and the like to the dispersion, stirring and mixing the resultant dispersion, followed by filtration.

Properties of Ink

A pH value of the ink is preferably in the range from 3 to 11, and particularly preferably in the range from 4.5 to 9.5. The pH value of the ink that contains a pigment having an anionic free radical on the surface of thereof is preferably in the range from 6 to 11, more preferably in the range from 6 to 9.5, and still more preferably in the range from 7.5 to 9.0. On the other hand, the pH value of the ink that contains a pigment having a cationic free radical on the surface thereof is preferably in the range from 4.5 to 8.0, and more preferably in the range from 4.5 to 7.0.

The viscosity of the ink is preferably in the range from 1.5 to 5.0 mPa.s, and more preferably in the range from 1.5 to 4.0 mPa.s. If the viscosity of the ink is more than 5.0 mPa.s, penetration into a recording paper becomes slower to thus sometimes cause intercolor bleeding. On the other hand, if the viscosity of the ink is less than 1.5 mPa.s, penetration into a recording paper is too fast to agglomerate the ink pigment and the anionic compound, leading to a reduced density and occurrence of bleeding since the ink penetrates deeply into the recording paper.

The surface tension of the ink may be adjusted mainly by controlling the addition amount of the surfactant preferably within a range of 25 to 37 mN/m. If the surface tension is less than 25 mN/m, penetration of the ink into the recording paper is too fast to agglomerate the ink colorant and the anionic water-soluble polymer, occasionally leading to a reduced density and bleeding of the print letters since ink penetrates into the interior of the recording paper. In contrast, if the surface tension is more than 37 mN/m, penetration of the ink may be retarded, to thereby impair dryness.

### EXAMPLES

The invention will now be fully described with reference to the examples, which are, however, illustrative only, and the invention is not limited to the examples. First, description is given of inks and recording papers of examples and comparative examples, and thereafter is given of results of various evaluation when printing is carried out using the inks and the recording papers in combination in several manners.

(1) Preparation of Ink

As to inks, there are prepared (i) a dye ink set and (ii) a pigment ink set.

<Ink Set (i) (color dye ink)>
-Magenta Ink-

| | | |
|---|---|---|
| Direct Red 227 (10% by weight aqueous solution) | 20 | parts by weight |
| Ethylene glycol | 25 | parts by weight |
| Urea | 5 | parts by weight |
| Surfactant (trade name: Surfynol 465 manufactured | 2 | parts by weight |
| by Nisshin Chemicals Co., Ltd.) | | |

Deionized water is added to the above composition to make a total amount of 100 parts by weight, then stirred for 30 min. Thereafter, the resultant mixture is filtered through a pore size 1 μm membrane filter. A surface tension of this ink is 31 mN/m and a viscosity thereof is 2.0 mPA·s.

-Cyan Ink-

| | | |
|---|---|---|
| Direct Blue 142 (10% by weight aqueous solution) | 20 | parts by weight |
| Ethylene glycol | 25 | parts by weight |
| Urea | 5 | parts by weight |
| Surfactant (trade name: Surfynol 465 manufactured | 2 | parts by weight |
| by Nisshin Chemicals Co., Ltd.) | | |

Deionized water is added to the above composition to make a total amount of 100 parts by weight, then stirred for 30 min. Thereafter, the obtained mixture is filtered through a pore size 1 μm membrane filter. A surface tension of this ink is 31 mN/m and a viscosity thereof is 2.0 mPa.s.

-Yellow Ink-

| | | |
|---|---|---|
| Direct Yellow 144 (10% by weight aqueous | 20 | parts by weight |
| solution) | | |
| Ethylene glycol | 25 | parts by weight |
| Urea | 5 | parts by weight |
| Surfactant (trade name: Surfynol 465 manufactured | 2 | parts by weight |
| by Nisshin Chemicals Co., Ltd.) | | |

Deionized water is added to the above composition to make a total amount of 100 parts by weight, then stirred for 30 min. Thereafter, the resulting mixture is filtered through a pore size 1 μm membrane filter. A surface tension of this ink is 31 mN/m and a viscosity thereof is 2.0

<Ink Set (ii) (pigment ink)>
-Black Ink-

| | | |
|---|---|---|
| Surface-treated pigment (trade name: Cab-o-jet 300 | 4 | parts by weight |
| manufactured by Cabot Corporation) | | |
| Styrene/maleic acid/sodium maleate copolymer | 0.5 | parts by weight |
| Diethylene glycol | 20 | parts by weight |
| Surfactant (trade name: Surfynol 465 manufactured | 0.5 | parts by weight |
| by Nisshin Chemicals Co., Ltd.) | | |
| Urea | 5 | parts by weight |
| Ion-exchanged water | 70 | parts by weight |

The above composition is stirred for 30 min. Thereafter, the resultant mixture is filtered through a pore size 1 μm membrane filter. A surface tension of this ink is 32 mN/m and a viscosity thereof is 2.8 mPa.s.

Cyan Ink

Surface-treated pigment (trade name: IJX-253 manufactured by Cabot

-Cyan Ink-

| | | |
|---|---|---|
| Surface-treated pigment (trade name: IJX-253 | 4 | parts by weight |
| manufactured by Cabot Corporation) | | |
| Styrene/maleic acid/sodium maleate copolymer | 0.5 | parts by weight |
| Diethylene glycol | 20 | parts by weight |
| Surfactant (trade name: Surfynol 465 manufactured | 0.5 | parts by weight |
| by Nisshin Chemicals Co., Ltd.) | | |
| Urea | 5 | parts by weight |
| Ion-exchanged water | 70 | parts by weight |

The above composition is stirred for 30 min. Thereafter, the obtained mixture is filtered through a pore size 1 μm membrane filter. A surface tension of this ink is 32 mN/m and a viscosity thereof is 2.5 mPa.s.

Magenta Ink

Surface-treated pigment (trade name: IJX-266 manufactured by Cabot

-Magenta Ink-

| | | |
|---|---|---|
| Surface-treated pigment (trade name: IJX-266 | 4 | parts by weight |
| manufactured by Cabot Corporation) | | |
| Styrene/maleic acid/sodium maleate copolymer | 0.5 | parts by weight |
| Diethylene glycol | 20 | parts by weight |
| Surfactant (trade name: Surfynol 465 manufactured | 0.5 | parts by weight |
| by Nisshin Chemicals Co., Ltd.) | | |
| Urea | 5 | parts by weight |
| Ion-exchanged water | 70 | parts by weight |

The above composition is stirred for 30 min. Thereafter, the resulting mixture is filtered through a pore size 1 μm membrane filter. A surface tension of this ink is 33 mN/m and a viscosity thereof is 2.7 mPa.s.

Yellow Ink

Surface-treated pigment (trade name: IJX-273 manufactured by Cabot

-Yellow Ink-

| | | |
|---|---|---|
| Surface-treated pigment (trade name: IJX-273 | 4 | parts by weight |
| manufactured by Cabot Corporation) | | |
| Styrene/maleic acid/sodium maleate copolymer | 0.5 | parts by weight |
| Diethylene glycol | 20 | parts by weight |
| Surfactant (trade name: Surfynol 465 manufactured | 0.5 | parts by weight |
| by Nisshin Chemicals Co., Ltd.) | | |
| Urea | 5 | parts by weight |
| Ion-exchanged water | 70 | parts by weight |

The above composition is stirred for 30 min. Thereafter, the resultant mixture is filtered through a pore size 1 μm membrane filter. A surface tension of this ink is 33 mN/m and a viscosity thereof is 2.7 mPa.s.

(2) Preparation of Recording Paper

The following recording papers (1) to (11) are prepared.

<Recording Paper (1)>

Dry pulp made of hardwood kraft pulp for which beating is adjusted to give a freeness of 530 ml is disintegrated into a wet mass of separate fibers, whereby a pulp dispersion having a pulp solids content of 0.3% by weight is prepared.

Into the pulp dispersion, there are added: 0.1 parts by weight of a succinic anhydride (ASA) internal sizing agent (trade name: Fibran-81 manufactured by Nippon NSC, Ltd.); and 0.5 parts by weight of cationized starch (trade name: Cato-304 manufactured by Nippon NSC, Ltd.) relative to 100 parts by weight of a pulp solids content in the pulp dispersion, and a wet soft paper sheet is made using an experimental orientation paper machine (manufactured by Kumagai Riki Kogyo K.K.) under the conditions where an 80 mesh wire is used, a wire speed is 1000 m/min and a paper material discharge pressure is 1.5 kg/cm². Thereafter, the soft wet paper sheet is compressed at a pressure of 10 kg/cm² for 3 min using a square sheet machine press (manufactured by Kumagai Riki Kogyo K.K.), followed by drying in a KRK rotary dryer (manufactured by Kumagai Riki Kogyo K.K.) at 110° C. and a feed rate of 0.5 m/min, thereby obtaining a recording paper (1) having a basis weight of 70 g/m².

A CD shrinkage rate of the recording paper (1) is 0.35%, a bending load is 0.042 N (4.3 gf) and an e/s value is 8.3. Further, an absorption coefficient measured through Bristow's method is 2.5.

<Recording Paper (2)>

A recording paper (2) having a basis weight of 70 g/m² is prepared in a similar manner to the recording paper (1), excepting that hardwood kraft keratinized pulp (Senibra pulp manufactured by Senibra Co.) for which beating is adjusted so as to attain a freeness of 560 ml is used instead of hardwood kraft pulp for which beating is adjusted to give a freeness of of 530 ml.

A CD shrinkage rate of the recording paper (2) is 0.35%, a bending load is 0.029 N (3.0 gf) and an e/s value is 12.1. Further, an absorption coefficient measured through Bristow's method is 3.0.

<Recording Paper (3)>

Dry pulp made of hardwood kraft pulp for which beating is adjusted to achieve a freeness of 480 ml is disintegrated into a wet mass of separate fibers, whereby a pulp dispersion having a pulp solids content of 0.3% by weight is prepared.

Into the pulp dispersion, there are added: 0.1 parts by weight of a succinic anhydride (ASA) internal sizing agent (trade name: Fibran-81 manufactured by Nippon NSC, Ltd.); and 0.5 parts by weight of cationized starch (trade name: Cato-304 manufactured by Nippon NSC, Ltd.) relative to 100 parts by weight of a pulp solids content in the pulp dispersion, and a wet soft paper sheet is made using an experimental orientation paper machine (manufactured by Kumagai Riki Kogyo K.K.) under the conditions where an 80 mesh wire is used, a wire speed is 1,000 m/min and a paper material discharge pressure is 1.5 kg/cm². Thereafter, the soft wet paper sheet is sandwiched between filter papers on both surfaces of the wet soft paper sheet and further sandwiched between metal plates placed on the respective filter papers, after which the composite set is compressed at a pressure of 10 kg/cm² for 3 min using a square sheet machine press (manufactured by Kumagai Riki Kogyo K.K.), followed by drying in a KRK rotary dryer (manufactured by Kumagai Riki Kogyo K.K.) at 110° C. and a feed rate of 0.5 m/min, thereafter the composite set after drying is subjected to a size press using a coating solution prepared to include 94 parts by weight of water, 1 part by weight of cationized starch (trade name: Ace K manufactured by Oji Cornstarch Co., Ltd.) and 5 parts by weight of calcium chloride. Then, the size-pressed composite set is dried using the cylinder dryer, thereby obtaining a recording paper (3) which contains 1 g/m² calcium chloride, as the polyvalent metal salt, at a surface thereof and has a basis weight of 70 g/m².

A CD shrinkage rate of the recording paper (3) is 0.38%, a bending load is 0.039 N (4.0 gf) and an e/s value is 9.7. Further, an absorption coefficient measured through Bristow's method is 1.3.

<Recording Paper (4)>

Dry pulp made of hardwood kraft pulp for which beating is adjusted to provide a freeness of 480 ml is disintegrated into a wet mass of separate fibers, whereby a pulp dispersion having a pulp solids content of 0.3% by weight is prepared.

Into the pulp dispersion, there are added: 0.1 parts by weight of a succinic anhydride (ASA) internal sizing agent (trade name: Fibran-81 manufactured by Nippon NSC, Ltd.); and 0.5 parts by weight of cationized starch (trade name: Cato-304 manufactured by Nippon NSC, Ltd.) relative to 100 parts by weight of a pulp solids content in the pulp dispersion, and a wet soft paper sheet is made using an experimental orientation paper machine (manufactured by Kumagai Riki Kogyo K.K.) under the conditions where an 80 mesh wire is used, a wire speed is 1,000 m/min and a paper material discharge pressure is 1.5 kg/cm². Thereafter, the soft wet paper sheet is sandwiched between filter papers on both surfaces of the wet soft paper sheet and further sandwiched between metal plates placed on the respective filter papers, after which the composite set is compressed at a pressure of 10 kg/cm² for 3 min using a square sheet machine press (manufactured by Kumagai Riki Kogyo K.K.), followed by drying in a KRK rotary dryer (manufactured by Kumagai Riki Kogyo K.K.) at 110° C. and a feed rate of 0.5 m/min, thereafter the composite set after drying is subjected to a size press using a coating solution prepared to include 95 parts by weight of water and 5 parts by weight of sodium alginate (trade name: Algin manufactured by Kimica Corporation) and the size-pressed composite set is dried in a cylinder dryer, thereby obtaining a recording paper (4) which contains 1 g/m² sodium alginate, as the polyvalent metal salt, at a surface thereof and has a basis weight of 70 g/m².

A CD shrinkage rate of the recording paper (4) is 0.36%, a bending load is 0.044 N (4.5 gf) and an e/s value is 8.2. Further, an absorption coefficient measured through Bristow's method is 1.0.

<Recording Paper (5)>

Dry pulp made of hardwood kraft pulp for which beating is adjusted to give a freeness of 480 ml is disintegrated into a wet mass of separate fibers using a machine (manufactured by Kumagai Riki Kogyo K.K.), whereby a pulp dispersion having a pulp solids content of 0.3% by weight is prepared.

Into the pulp dispersion, there are added: 6 parts by weight of heavy calcium carbonate (trade name: BF-200 manufactured by Bihoku Funkakogyo K.K.); 0.1 parts by weight of a succinic anhydride (ASA) internal sizing agent (trade name: Fibran-81 manufactured by Nippon NSC, Ltd.); and 0.5 parts by weight of cationized starch (trade name: Cato-304 manufactured by Nippon NSC, Ltd.) relative to 100 parts by weight of a pulp solids content in the pulp dispersion, and a wet soft paper sheet is made using an experimental orientation paper machine (manufactured by Kumagai Riki Kogyo K.K.) under the conditions where an 80 mesh wire is used, a wire speed is 1,000 m/min and a paper material discharge pressure is 1.5 kg/cm². Thereafter, the soft wet paper sheet is sandwiched between filter papers on both surfaces of the wet soft paper sheet and further sandwiched between metal plates placed on the respective filter papers, after which the composite set is compressed at a pressure of 10 kg/cm² for 3 min using a square sheet machine press (manufactured by Kumagai Riki Kogyo K.K.), followed by drying in a KRK rotary dryer (manufactured by Kumagai Riki Kogyo K.K.) at 110° C. and a feed rate of 0.5 m/min, thereby obtaining a recording paper (5) having a basis weight of 70 g/m².

A CD shrinkage rate of the recording paper (5) is 0.38%, a bending load is 0.046 N (4.7 gf) and an e/s value is 8.3. Further, an absorption coefficient measured through Bristow's method is 3.7.

<Recording Paper (6)>

Dry pulp made of hardwood kraft pulp for which beating is adjusted to attain a freeness of 480 ml is disintegrated into a wet mass of separate fibers using a machine (manufactured by Kumagai Riki Kogyo K.K.) whereby a pulp dispersion having a pulp solids content of 0.3% by weight is prepared.

Into the pulp dispersion, there are added: 5 parts by weight of fine powder silicic acid (trade name: Mizukasil manufactured by Mizusawa Industrial Chemicals, Ltd.); 0.1 parts by weight of a succinic anhydride (ASA) internal sizing agent (trade name: Fibran-81 manufactured by Nippon NSC, Ltd.); and 0.5 parts by weight of cationized starch (trade name: Cato-304 manufactured by Nippon NSC, Ltd.) relative to 100 parts by weight of a pulp solids content in the pulp dispersion, and a wet soft paper sheet is made using an experimental orientation paper machine (manufactured by Kumagai Riki Kogto K.K.) under the conditions where an 80 mesh wire is used, a wire speed is 750 m/min and a paper material discharge pressure is 1.5 kg/cm². Thereafter, the soft wet paper sheet is sandwiched between filter papers on both surfaces of the wet soft paper sheet and further sandwiched between metal plates placed on the respective filter papers, after which the composite set is compressed at a pressure of 10 kg/cm² for 3 min using a square sheet machine press (manufactured by Kumagai Riki Kogyo K.K.), followed by drying in a KRK rotary dryer (manufactured by Kumagai Riki Kogyo K. K.) at 110° C. and a feed rate of 0.5 m/min, thereby obtaining a recording paper (6) having a basis weight of 76 g/m².

A CD shrinkage rate of the recording paper (6) is 0.43%, a bending load is 0.052 N (5.3 gf) and an e/s value is 8.3. Further, an absorption coefficient measured through Bristow's method is 4.0.

<Recording Paper (7)>

Dry pulp made of hardwood kraft pulp for which beating is adjusted to attain a freeness of 480 ml is disintegrated into a wet mass of separate fibers using a machine (manufactured by Kumagai Riki Kogyo K.K.) whereby a pulp dispersion having a pulp solids content of 0.3% by weight is prepared.

Into the pulp dispersion, there are added: 0.5 parts by weight of a succinic anhydride (ASA) internal sizing agent (trade name: Fibran-8 1 manufactured by Nippon NSC, Ltd.); and 0.5 parts by weight of cationized starch (trade name: Cato-304 manufactured by Nippon NSC, Ltd.) relative to 100 parts by weight of a pulp solids content in the pulp dispersion, and a wet soft paper sheet is made using an experimental orientation paper machine (manufactured by Kumagai Riki Kogyo K.K.) under the conditions where an 80 mesh wire is used, a wire speed is 1000 m/min and a paper material discharge pressure is 1.5 kg/cm². Thereafter, the soft wet paper sheet is sandwiched between filter papers on both surfaces of the wet soft paper sheet and further sandwiched between metal plates placed on the respective filter papers, after which the composite set is compressed at a pressure of 10 kg/cm² for 3 min using a square sheet machine press (manufactured by Kumagai Riki Kogyo K.K.), followed by drying in a KRK rotary dryer (manufactured by Kumagai Riki Kogyo K.K.) at 110° C. and a feed rate of 0.5 m/min, thereby obtaining a recording paper (7) having a basis weight of 70 g/m².

A CD shrinkage rate of the recording paper (7) is 0.35%, a bending load is 0.025 N (2.5 gf) and an e/s value is 14. Further, an absorption coefficient measured through Bristow's method is 0.2.

<Recording Paper (8)>

Dry pulp made of hardwood kraft pulp for which beating is adjusted to achieve a freeness of 200 ml is disintegrated into a wet mass of separate fibers using a machine (manufactured by Kumagai Riki Kogyo K.K.) whereby a pulp dispersion having a pulp solids content of 0.3% by weight is prepared.

Into the pulp dispersion, there are added: 0.1 parts by weight of a succinic anhydride (ASA) internal sizing agent (trade name: Fibran-81 manufactured by Nippon NSC, Ltd.); and 0.5 parts by weight of cationized starch (trade name: Cato-304 manufactured by Nippon NSC, Ltd.) relative to 100 parts by weight of a pulp solids content in the pulp dispersion, and a wet soft paper sheet is made using an experimental orientation paper machine (manufactured by Kumagai Riki Kogyo K.K.) under the conditions where an 80 mesh wire is used, a wire speed is 1000 m/min and a paper material discharge pressure is 1.5 kg/cm². Thereafter, the soft wet paper sheet is sandwiched between filter papers on both surfaces of the wet soft paper sheet and further sandwiched between metal plates placed on the respective filter papers, after which the composite set is compressed at a pressure of 10 kg/cm² for 3 min using a square sheet machine press (manufactured by Kumagai Riki Kogyo K.K.), followed by drying in a KRK rotary dryer (manufactured by Kumagai Riki Kogyo K.K.) at 110° C. and a feed rate of 0.5 m/min, thereby obtaining a recording paper (8) having a basis weight of 70 g/m².

A CD shrinkage rate of the recording paper (8) is 0.59%, a bending load is 0.032 N (3.3 gf) and an e/s value is 18.4. Furthermore, an absorption coefficient measured through Bristow's method is 2.5.

<Recording Paper (9)>

Dry pulp made of hardwood kraft pulp for which beating is adjusted to attain a freeness of 480 ml is disintegrated into a wet mass of separate fibers using a machine (manufactured by Kumagai Riki Kogyo K.K.) whereby a pulp dispersion having a pulp solids content of 0.3% by weight is prepared.

Into the pulp dispersion, there are added: 0.1 parts by weight of a succinic anhydride (ASA) internal sizing agent (trade name: Fibran-81 manufactured by Nippon NSC, Ltd.); and 0.5 parts by weight of cationized starch (trade name: Cato-304 manufactured by Nippon NSC, Ltd.) relative to 100 parts by weight of a pulp solids content in the pulp dispersion, and a wet soft paper sheet is made using an experimental orientation paper machine (manufactured by Kumagai Riki Kogyo K.K.) under the conditions where an 80 mesh wire is used, a wire speed is 1000 m/min and a paper material discharge pressure is 1.5 kg/cm². Thereafter, the soft wet paper sheet is sandwiched between filter papers on both surfaces of the wet soft paper sheet and further sandwiched between metal plates placed on the respective filter papers, after which the composite set is compressed at a pressure of 10 kg/cm² for 3 min using a square sheet machine press (manufactured by Kumagai Riki Kogyo K.K.) and the compressed composite set is calendered at a pressing line pressure of 60 kg/cm using a calendering machine (manufactured by Kumagai Riki Kogyo K.K.), followed by drying in a KRK rotary dryer (manufactured by Kumagai Riki Kogyo K.K.) at 110° C. and a feed rate of 0.5 m/min, thereby obtaining a recording paper (9) having a basis weight of 70 g/m².

A CD shrinkage rate of the recording paper (9) is 0.53%, a bending load is 0.032 N (3.3 gf) and an e/s value is 16.6. Further, an absorption coefficient measured through Bristow's method is 2.5.

<Recording Paper (10)>

Dry pulp made of hardwood kraft pulp for which beating is adjusted to provide a freeness of 480 ml is disintegrated into a wet mass of separate fibers using a machine (manufactured by Kumagai Riki Kogyo K.K.) whereby a pulp dispersion having a pulp solids content of 0.3% by weight is prepared.

Into the pulp dispersion, there are added: 10 parts by weight of heavy calcium carbonate (trade name: Softon 1200 manufactured by Bihoku Funkakogyo K.K.); and 0.5 parts by weight of cationized starch (trade name: Cato-304 manufactured by Nippon NSC, Ltd.) relative to 100 parts by weight of a pulp solids content in the pulp dispersion, and a wet soft paper sheet is made using an experimental orientation paper machine (manufactured by Kumagai Riki Kogyo K.K. )under the conditions where an 80 mesh wire is used, a wire speed is 1,000 m/min and a paper material discharge pressure is 1.5 kg/cm². Thereafter, the soft wet paper sheet is sandwiched between filter papers on both surfaces of the wet soft paper sheet and further sandwiched between metal plates placed on the respective filter papers, after which the composite set is compressed at a pressure of 10 kg/cm² for 3 min using a square sheet machine press (manufactured by Kumagai Riki Kogyo K.K.), followed by drying in a KRK rotary dryer (manufactured by Kumagai Riki Kogyo K.K.) at 110° C. and a feed rate of 0.5 m/min, thereby obtaining a recording paper (10) having a basis weight of 70 g/m².

A CD shrinkage rate of the recording paper (10) is 0.48%, a bending load is 0.032 N (3.3 gf) and an e/s value is 15. Further, an absorption coefficient measured through Bristow's method is 4.3.

<Recording Paper (11)>

Dry pulp made of hardwood kraft pulp for which beating is adjusted to give a freeness of 480 ml is disintegrated into a wet mass of separate fibers using a machine (manufactured by Kumagai Riki Kogyo K.K.) whereby a pulp dispersion having a pulp solids content of 0.3% by weight is prepared.

Into the pulp dispersion, there are added: 0. 1 parts by weight of a succinic anhydride (ASA) internal sizing agent (trade name: Fibran-8 1 manufactured by Nippon NSC, Ltd.); and 0.5 parts by weight of cationized starch (trade name: Cato-304 manufactured by Nippon NSC, Ltd.) relative to 100 parts by weight of a pulp solids content in the pulp dispersion, and a wet soft paper sheet is made using an experimental orientation paper machine (manufactured by Kumagai Riki Kogyo K.K.) under the conditions where an 80 mesh wire is used, a wire speed is 1000 m/min and a paper material discharge pressure is 1.5 kg/cm². Thereafter, the soft wet paper sheet is sandwiched between filter papers on both surfaces of the wet soft paper sheet and further sandwiched between metal plates placed on the respective filter papers, after which the composite set is compressed at a pressure of 10 kg/cm² for 3 min using a square sheet machine press (manufactured by Kumagai Riki Kogyo K.K.), followed by drying in a KRK rotary dryer (manufactured by Kumagai Riki Kogyo K.K.) at 110° C. and a feed rate of 0.5 m/min. Thereafter the composite set after drying is subjected to a size press using a surface sizing agent (trade name: Polymaron 1354 manufactured by Arakawa Chemical Industries, Ltd.) to give a coating amount of 5 g/m², followed by additional drying, thereby obtaining a recording paper (11) having a basis weight of 75 g/m².

A CD shrinkage rate of the recording paper (11) is 0.42%, a bending load is 0.049 N (5.0 gf) and an e/s value is 8.6. Further, an absorption coefficient measured through Bristow's method is 0.1.

(3) Evaluation Result

Printing is conducted using the inks and the recording papers prepared as above in combination, employing a thermal inkjet recording apparatus. The results of printing evaluated are shown in Table 1.

One-sided printing was performed, at an atmosphere of 23° C. and 50% RH, using a multi-pass type thermal inkjet recording apparatus which is installed with 4 recording heads each having an ink ejecting nozzle pitch at 800 dpi and 25 ink ejecting nozzles, at an ejecting amount of about 15 pl and a head scanning speed of about 28 cm/sec.

TABLE 1

| | | | | | | Evaluation Results | | | |
|---|---|---|---|---|---|---|---|---|---|
| | | Recording Paper | | | | | | Curling after | |
| | | | | | Coating | Curling | Warping | allowed to | |
| | Ink | | Absorption | | Amount | immediately | immediately | Stand for | Image |
| | No. | No. | Coefficient | E/s | (g/m²) | after Printing | after Printing | Drying | Quality |
| Example 1 | Ink Set (ii) | Recording Paper (1) | 2.5 | 8.3 | 0 | ◯ | ◯ | ◯ | ◯ |
| Example 2 | Ink Set (ii) | Recording Paper (2) | 3.0 | 12.1 | 0 | ⊚ | ⊚ | ⊚ | ◯ |
| Example 3 | Ink Set (ii) | Recording Paper (3) | 1.3 | 9.7 | Polyvalent | ⊚ | ⊚ | ⊚ | ⊚ |
| | | | | | Metal Salt | | | | |
| | | | | | 1 g/m² | | | | |
| Example 4 | Ink set (ii) | Recording Paper (4) | 1.0 | 8.2 | 0 | ◯ | ◯ | ◯ | ◯ |
| Example 5 | Ink Set (ii) | Recording Paper (5) | 3.7 | 8.3 | 0 | ◯ | ◯ | ⊚ | ◯ |
| Example 7 | Ink Set (ii) | Recording Paper (6) | 4.0 | 8.3 | 0 | ◯ | ◯ | ⊚ | ◯ |
| Example 8 | Ink Set (i) | Recording Paper (1) | 2.5 | 8.3 | 0 | ◯ | ◯ | ◯ | ◯ |
| Comparative | Ink Set (ii) | Recording Paper (7) | 0.2 | 14 | 0 | X | X | ⊚ | X |
| Example 1 | | | | | | | | | |
| Comparative | Ink Set (ii) | Recording Paper (8) | 2.5 | 18.4 | 0 | X | X | X | ◯ |
| Example 2 | | | | | | | | | |
| Comparative | Ink Set (i) | Recording Paper (9) | 2.5 | 16.6 | 0 | X | X | X | ◯ |
| Example 3 | | | | | | | | | |
| Comparative | Ink Set (ii) | Recording Paper (10) | 4.3 | 15 | 0 | ⊚ | ⊚ | X | ◯ |
| Example 4 | | | | | | | | | |
| Comparative | Ink Set (ii) | Recording Paper (11) | 0.1 | 8.6 | Surface | ⊚ | ⊚ | ⊚ | X |
| Example 5 | | | | | Sizing Agent | | | | |
| | | | | | 5 g/m² | | | | |

Evaluations summarized in Table 1 are performed in the following manner:

Evaluation of Curling Immediately after Printing

Magenta 100% solid image is printed on a recording paper in a postal card form with a margin of 5 mm, and evaluated for a hanging curling generation at one face opposite to a printing face immediately after printing. Evaluation of the hanging curling generation is performed by converting the obtained value into a curvature. Evaluating criteria are shown below in which symbols \hat{∘} and ◯ indicate acceptable levels.

\hat{∘}: Less than 20 m⁻¹

◯: 20 m⁻¹ or more and less than 35 m⁻¹

Δ: 35 m⁻¹ or more and less than 50 m⁻¹

X: 50 m⁻¹ or more

Evaluation of Warping Immediately after Printing

A secondary color 100% solid (Blue) image is printed in an area of 2 cm×2 cm located in the center of a recording paper in the postal card form, and assessed for a maximum height of warping immediately after printing using a laser displacement gauge. Evaluating criteria are shown below in which symbols \hat{∘} and ◯ indicate acceptable levels.

\hat{∘}: Less than 1 mm

◯: 1 mm or more and less than 2 mm

Δ: 2 mm or more and less than 3 mm

X: 3 mm or more

Evaluation of Curling After Ink is Allowed to Stand for Drying

Magenta 100% solid image is printed on a recording paper in the postal card form with a margin of 5 mm, and evaluated for a hanging curling generation at one face opposite to a printing face after 100 hr elapses post-printing while allowed to stand on a flat surface with a printing face appearing upside at an atmosphere of 23° C. and 50% RH. Evaluation of the hanging curling generation is performed by converting the obtained value into a curvature. Evaluating criteria are shown below in which symbols \hat{∘} and ◯ indicate acceptable levels.

\hat{∘}: Less than 20 m⁻¹

◯: 20 m⁻¹ or more and less than 35 m⁻¹

Δ: 35 m⁻¹ or more and less than 50 m⁻¹

X: 50 m⁻¹ or more

Evaluation of Image Quality

Magenta 100% solid image is printed on a recording paper in the postal card form with a margin of 5 mm, and assessed for image quality as shown below.

\hat{∘}: A vivid color is developed

◯: A vivid color is not developed, however, with no bleeding of the image

X: White spots are observed on the image with bleeding and the ink is transferred to a finger when touched

As detailed above, the present invention can provide a recording paper that, when printing is performed by inkjet recording, has improved in an image quality formed on a document, is capable of suppressing curling and warping immediately after printing to thus achieve two-sided printing, is capable of suppressing curling and warping after ink is allowed to stand for drying, and that is also capable of being used in electrophotographic image forming, as well as a recording method using the recording paper.

What is claimed is:

1. A recording paper comprising a cellulose pulp, said recording paper having an ink receiving layer with a mass per unit area being 0 g/m² or greater and less than 5 g/m² on one surface, wherein an absorption coefficient of the recording paper is in a range of 0.5 to 4, and an e/s value represented by the following equation (1) is 15.3 or less:
e/s=CD shrinkage rate (%)/bending load (N). Equation (1)

2. The recording paper according to claim 1, the ink receiving layer containing at one surface thereof a water-soluble binder and a polyvalent metal salt, wherein the content of the polyvalent metal salt is in a range of 0.1 to 2 g/m².

3. The recording paper according to claim 1, wherein the e/s value is 10.2 or less.

4. The recording paper according to claim 1, wherein the absorption coefficient is in a range of 1.0 to 3.0.

5. The recording paper according to claim 1, wherein the cellulose pulp contains waste paper pulp.

6. The recording paper according to claim 1, wherein the cellulose pulp is bleached by an elementally chlorine free (ECF) bleaching method or a totally chlorine free (TCF) bleaching method.

7. The recording paper according to claim 5, wherein a mixing proportion of the waste paper pulp in the cellulose pulp is in a range of 50% to 100%.

8. The recording paper according to claim 1, wherein a basis weight of the recording paper is in a range of 60 to 128 g/m².

9. The recording paper according to claim 2, wherein the content of the polyvalent metal salt is in a range of 0.5 to 1.5 g/m².

10. The recording paper according to claim 1, further comprising an internal sizing agent selected from the group consisting of a neutral rosin sizing agent, an alkenyl succinic anhydride (ASA), alkylketene dimer (AKD), and a petroleum resin sizing agent.

11. A recording method comprising recording using an inkjet ink on a recording paper that comprises a cellulose pulp and has an ink receiving layer with a mass per unit area being 0 g/m² or greater and less than 5 g/m² on one surface, wherein an absorption coefficient of the recording paper is in a range of 0.5 to 4, and an e/s value represented by the following equation (2) is 15.3 or less:
e/s=CDshrinkage rate (%)/bending load (N). Equation (2)

12. The recording method according to claim 11, wherein the inkjet ink contains a water-soluble colorant and has a surface tension in a range of 25 to 37 mN/m.

13. The recording method according to claim 11, wherein the inkjet ink contains a water-soluble polymer having at least a hydrophobic moiety and a hydrophilic moiety and has a surface tension in a range of 25 to 37 mN/m.

14. The recording method according to claim 11, wherein the recording paper contains at one surface thereof a water-soluble binder and a polyvalent metal salt, wherein the content of the polyvalent metal salt is in a range of 0.1 to 2 g/m².

15. The recording method according to claim 11, wherein the e/s value of the recording paper is 10.2 or less.

16. The recording method according to claim 11, wherein the absorption coefficient of the recording paper is in a range of 1.0 to 3.0.

17. The recording method according to claim 11, wherein the cellulose pulp in the recording paper contains waste paper pulp.

18. The recording method according to claim 11, wherein the inkjet ink contains a pigment and has a surface tension in a range of 25 to 37 mN/m.

19. A recording method comprising recording using an electrophotographic toner on a recording paper that comprises a cellulose pulp and has an ink receiving layer with a mass per unit area being 0 g/m² or greater and less than 5 g/m² on one surface, wherein an absorption coefficient of the recording paper is in a range of 0.5 to 4, and an e/s value represented by the following equation (2) is 15.3 or less:
e/s=CD shrinkage rate (%)/bending load (N). Equation (2)
